(19) United States
(12) Patent Application Publication
(10) Pub. No.: US 2003/0186807 A1
(43) Pub. Date: Oct. 2, 2003

(54) Hydrogel product for adsorption purposes

(76) Inventors: Jerker Porath, Uppsala (SE); Bo Ersson, Uppsala (SE)

Correspondence Address: Michael R Ward, Morrison & Foerster, 425 Market Street, San Francisco, CA, 94105-2482, US

(21) Appl. No.: 10/297,544

(22) PCT Filed: Jun. 7, 2001
(86) PCT No.: PCT/SE01/01278

(30) Foreign Application Priority Data
Jun. 8, 2000 (SE) 0002152-7

(51) Int. Cl. B01J 20/26

(52) U.S. Cl. 502/403; 502/402

(57) ABSTRACT

The present invention relates to a hydrogel product for adsorption purposes where an in water insoluble support matrix is cross-linked with polymers which give rise to an in water swellable adsorbent. Further the polymers are internally cross-linked through at least one cross-linking agent. As a support matrix an organic polymer is used or a combination of such; e.g. polysaccharide such as agar, cellulose, starch and so on, protein and components of protein and polysaccharide. The support matrix is substituted with a first, soluble polymer material chemically bound to the support matrix, whereupon additional polymer materials optionally are built-in in the primary synthesised support matrix complex through different kinds of cross-links, wherein optionally the support matrix is present in the form of an acid- and base-stable residue.

The present invention relates to a hydrogel product for adsorption purposes where an in water non-soluble support matrix is cross-linked with polymers which gives rise to an in water swellable adsorbent. As a support matrix an organic polymer or a combination of such e.g. polysaccharides such as agar, cellulose, starch etc., protein and components of protein and polysaccharide. Further the cross-linking polymers above have been cross-linked internally.

The present invention aims for achieving an improved adsorbent which selectively binds different materials, preferably metals.

Further the invention aims for an adsorbent which may be regenerated with required powerful means, without causing the adsorbent being unusable, e.g. looses its form, e.g. elution with 20% H₂SO₄.

Further the invention aims for an adsorbent which effectively may bind and concentrate poisonous compounds and which is cheap enough for making an economically harmless rendering possible of such material through e.g. dumping.

Further the invention aims for an adsorbent, which makes possible economical recycling of small amounts of valuable metals from large quantities of waste.

These objects are achieved and further advantages are obtained with the adsorbent according to the invention which in its most common embodiment is based upon a support matrix consisting of polysaccharide, or other material as set out below in the present description, to which different polymers have been cross-linked with other cross-linking agents. The support matrix may also consist of protein or a mixture of protein and polysaccharide.

A polysaccharide such as agarose and cellulose may be regarded as thread-shaped molecules consisting of monomer units containing several hydroxyl groups and internal and external ether bonds (acetal bonds), which taken together give the polysaccharide affinity to water (it is said to be hydrophilic). Such polymers form in water swellable gels with hydroxyls as targets for substitution.

Alkylation of the hydroxyls needs in general a strong alkaline environment. The present invention relates to a product in which adjacent amino groups have been incorporated into the matrix. These amino groups may be alkylated under less drastic conditions (lower alkalinity than the hydroxyls).

The amino groups are part of polyalkylene imines (which actually ought to be called polyalkylene amines) which first are coupled to the polysaccharide. This may be done at a high pH, e.g. 13 to 14. If an oligoethylene imine or polyethylene amine is selected the amino group density will be higher than the hydroxyl density in the original gel network, which is an advantage for the production of the product. The above polyalkylene imines are internally cross-linked through additional addition of cross-linking agents when a suitable amount of layers of polyalkylene imines have been added to the support matrix.

U.S. Pat. No. 4,144,190, 1979 (Bowes et al) has disclosed a polysaccharide adsorbent produced from a polysaccharide and a nitrogen-containing polymer which is possible to acetylate with a cross-linking substance. Steinmann et al (Talanta, Vol. 41, No. 10, pp. 1707-1713) synthesized a similar metal adsorbent from agarose and polyethylene amine. The metal ions Co²⁺, Ni²⁺, Cu²⁺, Zn²⁺, Cd²⁺, and UO₂²⁺ were studied. Our adsorbent differs from these metal adsorbents in that the carbon/protein component (support matrix) may be hydrolyzed with a strong acid without causing the product changing form macroscopically. This component may also be decomposed by oxidation with saturated sodium periodate solution, where the gel thus maintains its form despite these drastic treatments. If the product is being produced in the form of particles these may after acid treatment be packed in beds which allow high filtration velocities. These characteristics are obtained by coupling together a soluble polymer with a carbohydrate-polyamine complex in a non-soluble (gel) form with a cross-linking reagent.

G. P. Royer and his group of scientists describe (J. Am. Chem. Soc. 99, 1977, pp. 6141-42, J. Org. Chem. 45 (1980) 2269) how an inorganic core in the form of an aluminium hydroxide gel is treated with polyethylene amine followed by glutaraldehyde and a reaction of the “Schiff” product with sodium boron hydride. The aluminium hydroxide is thereafter dissolved with hydrochloric acid. The differences between this product and the product according to the present invention are among other things as follows:

1. We use organic polymer preferably polysaccharide and/or protein as support matrix or core material.

2. At least two, often many layers of polyethylene imine are coupled together between themselves and with the support matrix. Further the layers are cross-linked internally through addition of a cross-linking agent. The difference becomes particularly evident when the polymer former is a low molecular alkylene amine such as e.g. tetraethylene pentamine (TEPA). Here the cross-linking agent may outweigh the polyethylene amine component in the end product.

3. After the hydrolytic destruction (degradation) of the polysaccharide and/or the protein by means of an acid or base an acid- and base-stable residue remains from this (i.e. the support matrix) which may be manipulated chemically (e.g. be substituted). This is not the case with an inorganic core; thus, no substitutable remainder is obtained with the invention according to Royer et al. This is an advantage when the polyalkylene amine product becomes hydrofilized with this remainder most of which ought to have the structures —X—O—CH₂—CHOH—CH₂OH and —X—O—CH₂—CH₂OH where X is a cross-linking structure which has arisen at the coupling. Thus, we have after the acid treatment a stable product with both NH₂, NH groups and OH groups, any of which may be activated and substituted (with the same or different substituents). Also after acid treatment, followed by periodate treatment and final reduction with sodium boron hydride a polyethylene imine complex remains with attached residues of polysaccharides. These residues ought to mainly have the structures —CH₂—CHOH—CH₂OH and —CH₂—CH₂OH with the cross-link to the polyethylene amine still there. These structures are to be regarded as a glycerol ether and a glycol ether, respectively, and therefore it makes the product more hydrophilic and biocompatible (and thus more lenient to biological material). The glycerol and glycol residues may be activated and thereafter substituted. As a higher pH is required for the activation of an aliphatic hydroxyl than an amine the polyamine and alcohol components may independently be activated and substituted. One may therefore substitute the polyamine with a metal chelating agent and the alcohol groups with another group, e.g. an aromatic substance and thus obtain an adsorbent with double functions. Thus, such an adsorbent may be produced which is resistant to a strong acid as well as a base.

4. In the invention according to Royer at al an inorganic core material is included and the polyethylene amine is not coupled to this in chemical combination but the contact is through physical adsorption and through filling of canals and pores with polyethylene amine (PEI) before cross-linking. The efficiency of the capillary penetration may be questioned. According to the present invention the time for contact between the polyamine and the activated solid phase may be made very long. All permeably available canals and pores with active groups may then react with penetrating polymer and there be fixed. Thus, the contacting between the reacting components is therefore totally different.

A hydrogel for adsorption purposes is further described in PCT/SE99/00991 (WO99/64149). There a gel is described where you have a support matrix which is cross-linked to the polymers such as TEPA. However, there is no internal cross-linking within the polymers. Because this last-mentioned cross-linking is missing, the rigidity (stability) is reduced in this above-mentioned gel. Further you may suspect that there is a risk for the cross-linkings therein which may counteract through sterical hindrance the metal ion binding. You may thus expect achieving an adsorption maximum and thereafter a gradual lowering of the capacity.

Our adsorbent according to the present invention thus differs from these above-mentioned metal adsorbents within the prior art among other things that the carbon/protein component (support matrix) may undergo drastic treatments without the product macroscopically changing shape, and that an internal cross-link is present between/within the polymers which has been added to the support matrix, which gives a more rigid gel. If the product then is manufactured in the form of particles these may after treatment be packed in beds which allow for high filtration velocities.

Thus, we have achieved a novel adsorbent which overcomes earlier known stability problems in metal adsorbents. By the internal cross-linking of the polymers (polyamines) on the support matrix the rigidity increases. Furthermore, we may use higher filtration velocities (flow velocities) when using the present invention in comparison with other particle beds having similar dimensions, which may be of huge advantage in e.g. large-scale processes. By the cross-linking the chemical stability increases, which thus reduces the risk for extraction of soluble polymer products which is undesirable when an adsorbent according to the present invention shall be used for the manufacture of extremely pure substances, e.g. ultra-fine water. Cross-linking agents with their reactive group(s) which are added for achieving cross-links in the above-mentioned polymer enable further easy conversion of products to other adsorbents.

### SUMMARY OF THE INVENTION

The present invention relates to a hydrogel product for adsorption purposes consisting of an in water non-soluble support matrix and cross-linked polymers, characterized in that the support matrix is substituted with at least one first soluble polymer material which is chemically bound to the support matrix, whereafter optionally further polymer materials are built-in in the primarily synthesized support matrix polymer complex through different kinds of cross-links and that the polymer material is internally cross-linked, wherein optionally the support matrix is present in the form of an acid- and base-stable residue.

Further, the present invention relates to a process for the production of this above-mentioned hydrogel product, characterized in that polyalkylene amine chains A₁ are incorporated into the polysaccharide/protein network (i.e. the support matrix), which thereafter is activated and at the same time cross-linked with a cross-linking agent X₁, where an internal cross-link is obtained, whereupon the product optionally is coupled with one or more new alkylene amine(s) A₂-Aᵢ which thereupon is activated analogously with X₂-Xᵢ whereby additionally one or more internal cross-link(s) is (are) obtained (arise), whereupon further cross-linking agents Xₙ-X_{z} optionally may be added.

### DETAILED DESCRIPTION OF THE INVENTION

The wording “support matrix” is meant to embrace in the present application a matrix which is built up with a first, in water non-soluble polymer material. The invention is demonstrated in the form of a support matrix consisting of cross-linked spherical agarose particles but the support matrix may also comprise agar particles and polygalactanes (comprising polyglactose units), agarose or derivatives thereof, laminarine, cellulose (e.g. cotton) or derivatives thereof, cross-linked dextrane or derivatives thereof, and starch or derivatives thereof, and also proteins or a combination of polysaccharide and protein. Preferably the support matrix is present as a water-swollen gel when applying the polymers, i.e. e.g. polyethylene amine, most preferred a polyfunctional amine, e.g. polyethylene diamine.

The support matrix may instead of a polysaccharide comprise a protein with suitable side chains, which is the case with hair (wool) and silk. They contain e.g. OH from serine and —S—S groups which may be converted into —SH and amino groups. The OH-groups of serine may be converted into SH groups. (Ebert, C., Ebert, G., and Karipp, H. “On the introduction of disulphide cross-links into fibrous proteins and bovine serum albumin”, Advances in Experimental Medicine and Biology”, Vol. 86A, 1977, Plenum Press, New York, Editor M. Friedman, pp. 235-245. Thus, it is possible to build up a continuous polyamine around wool or silk thread. With the above-mentioned method for incorporating SH-groups the support matrix may be expanded to other proteins and protein complexes. The protein may be activated with a bifunctional reagent, e.g. a bisepoxide, an epichlorohydrine, a bishalohydrine, divinylsulphone, cyano halides, triazines, mono-, di- or polyaldehydes (e.g. glutaraldehyde) etc., whereupon the polyethylene amine may be coupled thereon later, after optionally a further coupling of polyethylene imine, polyethylene imine (preferably a polyethylene amine) is internally cross-linked in an analogous way as above.

The wording “internally cross-linked” is meant to embrace in the present application that the polymer(s) which is bound to the support matrix, preferably polyalkylene imine, is (are) cross-linked either between one of more polymers (preferably polyalkylene imine molecules) or the polymers (preferably polyalkylene imine molecules) are cross-linked within themselves.

A support matrix may be built up from both protein and polysaccharide, e.g. by mixing protein particles with agar in a hot solution which thereafter is allowed to congeal into a gel. A polyamine may then be built up around the gel component. In certain cases such a construction of the invention may offer certain advantages. The protein and the polysaccharide can separately be enzymatically degraded, alternatively the protein can be degraded in strong alkali, whereupon the polysaccharide can be degraded in acid. The intermediate may be substituted. Such a selective degradation may be valuable for the controlling of the porosity of the end product.

The invention may also be present in the shape of a pearl, thread, membrane, or may also be porous and spongy (foam plastic shaped). Thus, it may be present in a rather arbitrate form.

The wording “acid- and base-stable” is meant to embrace in the present application a residue which is formed when treating the support matrix with an acid, a base, an oxidation agent or a reduction agent. The acid may be H₂SO₄. The treatment with oxidizing agent may be performed with a saturated periodate solution at pH 7. The reduction agent may be sodium boron hydride.

The hydrogel product according to the present invention may also be described with the structural formula:

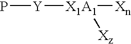

which also comprises the formula below (where the cross-linking agents, which achieve the internal cross-link, may be present in a multiple way on the polymer A₁):

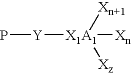

wherein P is the support matrix,

Y is a nitrogen, sulphur or oxygen bridge (which originates from the support matrix, or which may have been incorporated into the support matrix in another way);

Xᵢ . . . Xₙ . . . X_{z} are the same or different di-, tri- or polyfunctional cross-linking agents,

A₁ is a water soluble polymer material,

n is a whole number where n≧2; and z is 0 or a whole number where z≧0.

The hydrogel product according to the present invention may also be described with the structural formula:

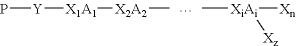

which also comprises the formula below (wherein the cross-linking agents, which achieve the internal cross-link, may be present in a multiple way on the polymer Aᵢ):

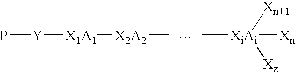

which in turn also comprises the formula below (wherein the cross-linking agents, which achieve the internal cross-link, may be present in a multiple way on the polymers A₁-Aᵢ):

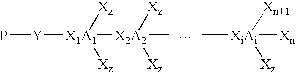

wherein P is the support matrix;

Y is a nitrogen, sulphur or oxygen bridge (which originates from the support matrix or which may have been incorporated into the support matrix in another way);

X₁ . . . Xᵢ . . . Xₙ . . . X_{z} are the same or different di, tri or polyfunctional cross-linking agents;

A₁ . . . Aᵢ are water soluble polymer materials, preferably the same or different kinds of cross-linked residues of amines; and

n and i are whole numbers where i≧2 and n≧2 and z is 0 or a whole number where z≧0. Thus, you may have a gradually branched network as set out in the last-mentioned formula.

Agar which may be support matrix, comprises OH groups which can be activated with bi- or multifunctional reagents such as bisepoxides and halohydrines. Agar thus provides in itself Y=O (i.e. oxygen). For Y=N or S these must first be incorporated into the agar. As an example of incorporation of S and N the following reactions may be given:

Agar-OH+Cl—CH₂—CH—CH₂→Agar-O—CH₂—CH—CH₂ (activated agar)

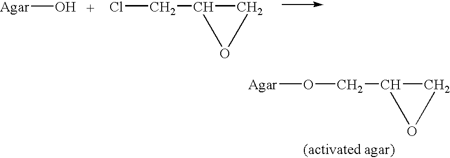

Activated agar+NaSH→Agar-O—CH₂—CHOH—CH₂—SH I)

Activated agar+NH₃→Agar-O—CH₂—CHOH—CH₂—NH₂ II)

A₁ . . . Aᵢ may be comprised of, one or more, residues of straight or branched oligo or polyalkylene amine (usually called polyalkylene imine), preferably oligo or polyethylene amine, or of residues from any of the amines NHR₁R₂, wherein R₁ may be identical with or differ from R₂ and R may be H, alkyl, aromatic or heterocyclic alkyl, carboxy alkyl or other amino acid, most preferred a polyalkylene diamine. Preferred among polyalkylene diamines is a polymer of ethylene diamine which is of a high molecular type, most preferred with a molecular weight in the size range≧2000 Da, especially preferred 2,000-100,000 Da (2,000-100,000 Dalton). The alkylene diamines which may be used for the production of the product in accordance with the present description may further be of low molecular type, e.g. tetraethylene pentamine (TEPA) or high molecular type, e.g. polyethylene imine (PEI) and polypropylene imine (PPI). The amine may have a linear molecule structure or it may be branched as e.g. tris (2-aminoethyl) amine, TREN. The invention relates generally to polyalkylene amines wherein polyethylene amine is one example. Experience gives at hand that polypropylene and polybutylene amine give products having characteristics which do not fundamentally differ from polyethylene variants. The latter are somewhat more hydrophilic. Furthermore, preferably polyalkylene diamines are used in the present invention such as polyethylene diamine and polypropylene diamine due to the probable forming of five and six ring structure, respectively (chelates) in the presence of metals, e.g. copper. For TEPA or PEI it may look like this:

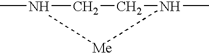

and for PPI like this:

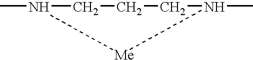

wherein Me=metal ion, e.g. Cu²⁺.

The polyalkylene imines work as a metal adsorbent wherein probably the metal ions are fixed in the polymer network. You may also thus call the gel product according to the present invention a metal chelate forming adsorbent or an ion exchanger.

A₁ or A₁ . . . Aᵢ, i.e. the polymer or the polymers above may further also be modified additionally. You may add reactions such as carboxylation, picolylation and so on under the conditions that not all of the sites for attack (for X, i.e. cross-linking agents) on A₁ or A₁ . . . Aᵢ are consumed (i.e. all amino groups). You may also modify through the addition of hydroxyl containing polymers, such as e.g. polyvinylalcohol, hydroxyethyl cellulose, starch, cellulose or neutral derivatives thereof. You may thus achieve a “protecting” layer for the polyamine or the polyamines. Examples of this may be:

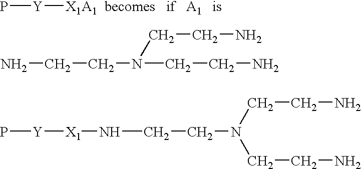

You may now carboxy methylate one of the NH₂ groups and thus you have a free amino group left which may react with X₂ and so on. Such incomplete substitutions (in this case alkylation) may be done at any step of the synthesis series.

The cross-linking agents can be of different kinds. They may be bi-, tri- or polyfunctional. The more activated functions the cross-linking agent possesses, the more efficient both the cross-linking and the activation will be. A trifunctional cross-linking agent as e.g. trihalotriazine or e.g. triepoxide may be working both as cross-linking agent and activator (activating agent). Cross-linking agents (cross-binding agents) may be halohydrine, epihalohydrine, bishalohydrine, divinyl sulphone, triazine, halodiazine or halotriazine, halohydrine, di-, tri- or polyepoxide, halodiazine or halotriazine, di-, tri- or polyfunctional aldehyde, preferably glutaraldehyde or polymerized glutaraldehyde, di-, tri- or polyaziridine, W₁-alkylene-W₂, wherein W₁ and W₂ is a halogen, preferably ethylene dibromide, or halogen cyanurate.

The cross-linking agents in the product may be of different kinds, wherein one or more cross-links may be broken and leave one or more other cross-links intact.

The invention according to the present description may further be characterized in:

1) that amino groups are incorporated into the water-swelled polygalactane gels (e.g. agar or agarose) in a constellation that binds metals, e.g. Cu²⁺ in chelate form,

2) a substitution according to 1) which enhances the concentration of a non-water-containing substance in the gel and thus enhances the mechanical stability of the gel,

3) that cross-linking enhances the mechanical stability further,

4) that, if the total number of amino groups is large and the amino polymer has been cross-linked strongly with many cross-links, a gel-formed residue product remains after that the support matrix (preferably polygalactane gel) has been broken down by hydrolysis and/or through oxidation. In order to obtain such a residue gel it may be advantageous that the number of amino groups is at least 10 and the number of cross-links at least 4. At 100 amino groups (PEI molecule weight approximately 4,000 Da) and 10 cross-links an insoluble acid-resistant gel product may be achieved. This gel product may be much more rigid if the number of amino groups in A₁ . . . Aᵢ is increased to 1,000. You may thus achieve a grading of the chemical characteristics of the gel product. The metal adsorption capacity increases when the number of amino groups in A₁ . . . Aᵢ is increased and at the same time the stability of the gel is increased. The rigidity and the chemical stability is enhanced with the increased number of cross-links (increasing value as regards Xᵢ).

The invention according to the present description has a considerable stability and it places itself in a preserved, original form also after a powerful chemical influence, e.g. elution, at treatment using a strong acid, e.g. 20% sulphuric acid, treatment using saturated periodate solution at pH 7, or at treatment using sodium boron hydride. By the internal cross-linking of polyamines the stability is further enhanced. If further the gel according to the present invention is treated with 30% sulphuric acid the support matrix is dissolved, which may leave only water-soluble products if you have not cross-linked sufficient polyamine on the support matrix. The support matrix is then degraded so that in the case of agar the polygalactane chains are hydrolysed to small fragments. If the gel according to the present invention has sufficient cross-links, i.e. that the cross-linking method has been done efficiently, then a gel-like residue remainder remains after the acid treatment. Preferably the polyamine is a high molecular polyamine. The more monomeric units of e.g. ethylene diamine which are involved in the internal cross-linking the more stable the gel will probably be for acid/base treatment. With 100 monomeric units and 10 cross-links a stable residue gel may be obtained. At a molecule weight over 42,000 Da, approx. 1,000 monomeric units, and a branched polymer network an even more stable residue gel may be obtained. The residue gel may after hydrolysis have (or even alcoholysis) the structures:

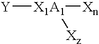

or

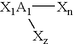

or

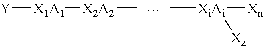

or

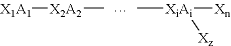

Of course these residues may be equipped with one or more X_{z} bound to A₁ or A₁-Aᵢ as for instance is disclosed below:

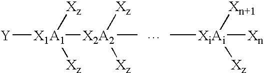

or

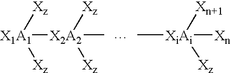

You may thus obtain a “pure” cross-linked A₁ or A₁-Aᵢ, that is without any support matrix or fragments thereof. If A₁ or A₁-Aᵢ are high polymer PEI an insoluble gel consisting of a cross-linked polyethylene amine may be obtained. Experiments 7 and 8 in the Example part illustrate the residue gels mentioned above in accordance with the present invention where there has been a treatment of cross-linked gel according to the present invention with a strong acid and a strong base, respectively.

In order to produce the product according to the present invention you may use different methods:

1. Polyalkylene imine chains A₁ are incorporated into the polysaccharide/protein network (support matrix) which thereafter is activated and at the same time is cross-linked with a cross-linking agent X₁, whereupon an internal cross-link is obtained, whereupon the product optionally is coupled with a new alkylene imine A₂ which thereupon is activated with X₂, whereupon a further internal cross-link is obtained, whereupon further cross-linking agents X₃-X_{z} may be added. X₃-X_{z} thus incorporates at least one non-reacted group. Further additional layers of polyalkylene imine chains may be added with an, of course, analogous addition of further cross-linking agents.

2. A cross-linked polyalkylene network is first cross-linked, whereupon it is coupled to the rigid polysaccharide/protein phase (the support matrix) which may be cross-linked polysaccharide/protein with or without polyalkylene imine coupled according to (1).

The product according to the present invention is thus obtainable by either of the above mentioned methods.

The processes according to (1) and (2) above may also comprise that the polysaccharide/protein network is subjected to degradation, whereupon an acid- and base-stable residue is obtained.

The cross-linking may also be performed in another way, i.e. through the cross-linking agent being built up on the amino units. This may be exemplified by allyl chloride or allyl bromide, e.g.

X—NH₂+CH₂═CH—CH₂Br→X—NH—CH₂—CH═CH₂ (I)

X=the residue of the polymer

The allyl amine is thereafter converted into a reactive form through halogenation, e.g. bromation with bromine water:

I+Br₂→X—NH—CH₂—CH₂Br—CHBr

I+HOBr→X—NH—CH₂—CHOH—CH₂Br

In an alkaline solution epoxide is formed. The bromated product may be coupled to amines as polyamines but also thioles.

This two step activation has certain advantages. The amino groups in the polyethylene imine are adjacent and ring closing comes under better control and a higher capacity may be obtained. Thus you obtain a process where the activation via the polyamine unit A₁ (or the polyamine units A₁-Aᵢ) is performed through a two step process where first unsaturated substituents, preferably alkenyl groups, most preferred allyl groups, are incorporated at the primary and/or secondary amino groups, whereupon the unsaturated substituents are desaturated with halogen water, preferably with bromine water, whereupon the coupling with the amines thereafter preferably takes place in an alkaline environment.

The activation and the coupling may be repeated several times or first a polyalkylene network is cross-linked, whereupon it is coupled to a solid polysaccharide/protein phase which may be cross-linked polysaccharide/protein with or without polyalkylene imine coupled according to what has been mentioned above.

When the thus formed polyethylene imine—polyethylene imine complex in its turn is cross-linked with optionally more polyethylene imine an increasingly higher molecular polyethylene imine complex is formed which through repeatedly similar operations gives an increasingly stable polymer complex. The thus treated particles keep their form and may thus be subjected to extremely drastic treatment such as with strong acid or base without the metal binding capacity being lost under the conditions that the cross-binding (linking) reagents such as epoxides, halohydrines or halogencyanurates have been used. When thereafter an internal cross-linking according to the present invention is performed on the polyethylene imine—polyethylene imine complex further enhanced stability will be achieved.

In order to produce the product according to the invention there is generally required that a sufficient number, i.e. at least one or more and optionally more reactions with oligo or polyethylene imine, is performed, wherein you obtain a sufficient number of layers with polyamine, preferably at least one layer on the support matrix, most preferred at least two layers, furthermore more preferred at least three layers. Thereupon internal cross-linking of polyamine is performed through addition of one of more cross-linking agents.

The characteristics of the product, according to the invention, depends on the density of the matrix (agarose concentration in the particles) and are reflected in how molecules of different sizes may penetrate into the matrix. Further the internal cross-linking is affected by the polyamines.

The explanations to why the metal ions are being absorbed by the matrix may also e.g. be thanks to the great amount of amino groups in the matrix which may achieve a Z-potential which is powerful enough for the ions to be caught. The free electron pairs in the amino groups may be those who participate actively when catching the ions. Thus, it may depend upon that there is some kind of reciprocal utilization of electrons (electron delocalization). Covalent bonding may be another explanation to that the invention works, like electrostatic forces.

Another explanation may be that ring-formed (or even spherical) structures are formed which let certain metal ions through but not others. The cross-linking of the polyamines are probably added to also this effect. In the long run you may also be able to specially adapt hydrogels according to the invention for special metals by using these metal ions as templates for achieving an adequate design of the gel.

These above explanations shall in no way be limiting for the scope of the invention but serve only for giving feasible explanations of how the invention according to the present invention works.

The invention may be present in the form of different particles, e.g. comprising a support matrix Novarose™ SE 10 (Novarose is a trademark owned by Inovata AB) which preferably is penetrated by protein molecules in average not much greater than 10 000 Dalton, Novarose SE 100 which is penetrated by molecules approximately ten times greater, and Novarose SE 1000 which is penetrated by molecules greater than 1 000 000 Dalton. You may also have a gel which is penetrated by protein molecules with an average size of up to 300 000 Dalton.

Application areas for the present invention may e.g. be within the area of environmental technique in order to remove undesirable metal ions from leachate. Of course a concentration of metal ions is obtained at the same time which may be desirable to achieve in other applications such as e.g. extracting of metals. Metallurgical industry may have use of this invention partly for removal of metal ions or partly for concentration of metal ions. The present invention, in particular the product, may further be used as support matrix during solid phase synthesis of peptides. Further, the gel according to the present invention may be used for fixing catalysts, e.g. palladium (Pd) or enzymes.

The invention will now be illustrated by the following examples. These examples shall in no way be limiting for the scope of the invention but shall only serve in an explanatory manner.

### EXAMPLES

Copper in all examples 1 to 6 below were analyzed with the help of chromatographic frontal analysis where copper was detected visually.

### Example 1

8 g of spherical cross-linked agar particles from INOVATA AB, Bromma, Sweden, “highly activated” by the incorporation of epoxide/halohydrine groups were suspended in 8 ml of water containing 4 g of polyethylene imine having a molecular weight of 750 000 Da (“PEI-750 000”) in a flask with a stopper which was put on a shaking table. The reaction was left to last during 20 hours. The gel was collected on a filter and washed with water. The product was henceforth called “Agar-PEI-750000”.

Agar-PEI-2000 was produced in an analogous way by coupling of polyethylene amine having a molecular weight of 2000 Da.

### Example 2

A 25 ml Erlenmeyer flask (E-flask) was equipped with 10 ml of 0.5 M Na₂CO₃, 0.5 ml butane diol-diglycidyl ether (BDG) and 1.5 g Agar-PEI-750000. The coupling reaction was performed at 60° C. during 70 minutes, whereupon the gel was suspended and was washed on filter with ethanol followed by water. The gel was henceforth called Agaros-PEI-750000-BDG. In an analogous way Agaros-PEI-2000-BDG was produced. 0.5 g of each gel was treated with 1 ml of 30% sulphuric acid at 70° C.

### Example 3

Analogously with Example 2 both gels were coupled according to Example 1 with 0.5 ml epichlorohydrine instead of BDG. The gels, called Agar-PEI-750000-EC and Agar-PEI-2000-EC, respectively, were treated in the same way as in Example 2 with 30% sulphuric acid.

### Example 4

In 25 ml E-flasks 1.5 g of both gels, which was synthesised according to Example 1, was suspended in a 0.5 M Na₂CO₃. 1.5 ml divinyl sulphone was added. The reaction was left to continue at room temperature and was terminated after 70 minutes. The gels were collected on filter and washed with water. The gels were called Agar-PEI-750000-DVS and Agar-PEI-2000-DVS. 0.5 g of each of the gels was suspended in 1 ml of 30% sulphuric acid and was heated to 70° C.

### Example 5

Experiments were performed with 1.5 g of the same Agar-PEI gels such as in Example 1 but with each of the gels suspended in 1 ml glutaraldehyde and 10 ml of water. The reaction went very quickly, whereupon the gels were red coloured. The gel coupled with PEI-2000 (Agar-PEI-2000-GA) became weaker red coloured than that with high molecular PEI (Agar-PEI-750000-GA). When the reaction was terminated after 70 minutes at 60° C. the gels had adopted a very deep red colour. The gels were collected on filter and were washed with water. The gels settled quicker than all gels according to Examples 1 to 4.

### Example 6

1.5 g each of PEI-2000 and PEI-750000 was suspended in a mixture of 0.5 ml of formalin and 10 ml of 1% acetic acid and was heated to 60° C. and the reaction was left to continue during 70 minutes, whereupon the gels were collected on filter and washed with water. 0.5 g of each gel was suspended in 30% sulphuric acid and the hydrolysis was left to continue at 70° C. The gels were called Agar-PEI-2000-F and Agar-PEI-750000-F.

Comments to the Results in Examples 1 to 6

A comparison of the gels after 17 hours of hydrolysis in 30% sulphuric acid at 70° C. showed that:

1) gel particles of all types remained,

2) best according to the appearance were gels cross-linked with bisepoxide (BBG), epichlorohydrine (EC) and glutaraldehyde (GA),

3) The PEI-750000 gels settled throughout the experiments quicker than the corresponding PEI-2000 gels in 30% sulphuric acid.

A further study was carried out, wherein gels were treated with 65% sulphuric acid during 1 hour at 50° C. The best gel was cross-linked with glutar aldehyde (GA). No change could be seen structurally, but the colour darkened. Nevertheless the end gel formed lumps.

Conclusion: The end material, the cross-linked agar, was remarkably acid stable. Despite the fact that glycoside bindings are cleaved the cross-linked gels tie the particle structures together. It thus appears as if a part of the polysaccharide material is dissolved in the first phase of the hydrolysis. A stable “core” appears to remain.

### Example 7

5 g of Sepharose 4B (non-cross-linked agarose in particle form obtained from Pharmacia Biotech, Uppsala, Sweden) was suspended in 20 ml of 0.5 M Na₂CO₃. 1 ml of divinyl sulphone (DVS) was added and the reaction was left to go during 20 hours at room temperature. The gel was collected on filter and was washed with ethanol followed by water.

The gel was suspended in 10 ml of water and 10 ml of 50% water solution of PEI-750000. The gel, called Agarose-DVS-PEI-750000, was divided into two parts. One part was suspended in 10 ml of water and 10 ml of 50% glutaraldehyde and the reaction was terminated after 1 hour and was further processed. The gel was red coloured. The gel was called Agarose-DVS-PEI-750000-GA. The other part was suspended in 10 ml of 0.5 M Na₂CO₃ and was equipped with 1 ml of epichlorohydrine. The gel was called Agarose-DVS-PEI-750000-EC. This gel was colourless.

### Example 8

Agarose-DVS-PEI-750000 and the two gels cross-linked according to Example 7 were treated over night at room temperature with 2 M NaOH. The gels were collected and washed on filter with distilled water, whereupon they were treated during one week in 50% sulphuric acid at room temperature.

Agarose-DVS-PEI-750000 was dissolved and formed a colourless solution in the 50% sulphuric acid. The two other gels, Agarose-DVS-PEI-750000-GA and Agarose-DVS-PEI-750000-EC left gel products having the same macroscopical appearance as the original agarose (Sepharose 4B) but adsorbed an essential amount of copper ions from copper sulphate solution. Further it was established that the gels after hydrolysis did not contain any sulphur. The latter showed that all divinyl sulphon bridges had been dissolved and the residue gels consisted of cross-linked polyethylene imine.

It should be understood that modifications can be made to the embodiments disclosed herein. Therefore the above description should not be construed as limiting, but merely as exemplification of preferred embodiments. Those skilled in the art will envision other modifications within the scope of the claims appended hereto.

1. A hydrogel product for adsorption purposes consisting of an in water non-soluble support matrix and cross-linked polymers, characterized in that the support matrix is substituted with at least one first, soluble polymer material chemically bound to the support matrix, whereupon optionally additional polymer materials are built-in in the primarily synthesised support matrix polymer complex through different kinds of cross-links and that the polymer material is internally cross-linked, wherein optionally the support matrix is present in the form of an acid- and base-stable residue.

2. A hydrogel product according to claim 1, characterized in that the cross-links are of different kinds whereby one or more cross-links may be broken open and leave one or more cross-links intact.

3. A hydrogel product according to claim 1, characterized in the structural formula 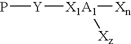
where P is the support matrix,
Y is a nitrogen, sulphur or oxygen bridge,
X₁ . . . Xₙ . . . X_{z} are the same or different di, tri or polyfunctional cross-linking agents,
A₁ is a water-soluble polymer material,
n is a whole number where n≧2; and z is 0 or a whole number where z≧0.

4. A hydrogel product according to claim 1, characterized in the structural formula: 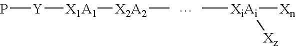
where P is a support matrix,
Y is a nitrogen, sulphur or oxygen bridge,
X₁ . . . Xᵢ . . . Xₙ . . . X_{z} are the same or different di-, tri- or poly-funktional cross-linking agents,
A₁ . . . Aᵢ are water-soluble polymer material preferably the same or different kinds of cross-linked residues of amines, and
n and i are whole numbers where i≧2 och n≧2; and z is 0 or a whole number where z≧0.

5. A hydrogel product according to any of the preceding claims, characterized in that the support matrix consists of a polysaccharide, polygalactane, agar, agarose or derivatives thereof, laminarine, cellulose of derivatives thereof, cross-linked dextran or derivatives thereof, or starch or derivatives thereof, and also proteins or a combination of a polysaccharide and a protein.

6. A hydrogel product according to any one of claims 3 or 4, characterized in that one or more cross-linking agents, X₁-Xₙ-X_{z}, is halohydrin, epihalohydrin, bishalohydrin, divinyl sulphon, di or polyepoxide, triazine, halodiazine or halotriazine, di-, tri- or polyfunctional aldehyde, preferably glutar aldehyde or polymerized glutaraldehyde, di-, tri- or polyaziridine, W₁-alkylene-W₂, wherein W₁ and W₂ are halogen, preferably ethylene bromide, or halogen cyanurate.

7. A hydrogel product according to any one of claims 3, 4 or 6, characterized in that one or more of A₁ . . . Aᵢ consist(s) of residues of a straight or branched polyalkylene amine (generally called polyalkylene amine), preferably oligo or polyethylene amine, or residues of any of the amines NHR₁R₂, where R₁ may be identical to or different from R₂ and R may be H, alkyl, aromatic or heterocyclic alkyl, carboxy alkyl or any other amino acid, most preferred a polyalkylene diamine.

8. A hydrogel product according to any one of the preceding claims, characterized by an arbitrary shape, preferably particular, suitably spherical, thread shape, membrane shape or even porous or spongy.

9. A hydrogel product according to any one of the preceding claims, characterized by a retained, original shape even after a powerful chemical influence, e.g. elution, at treatment using a strong acid, e.g. a 20% sulphuric acid, treatment using a saturated periodate solution at pH 7, or treatment using sodium boron hydride.

10. A process for the production of a hydrogel product according to claims 1 to 9, characterized in that a polyalkyleneimine chain A₁ is incorporated into the polysaccharide/protein network, i.e. the support matrix, which thereafter is activated and at the same time cross-linked with a cross-linking agent X₁, wherein an internal cross-link is obtained, whereupon the product optionally is coupled to one or more new alkylene amine(s) A₂ Aᵢ which thereupon are being activated analogously with X₂-Xᵢ wherein one or more internal cross-links are obtained, whereupon further cross-linking agents Xₙ-X_{z} optionally may be added.

11. A process according to claim 10, characterized in that the polysaccharide/protein network is subjected to a degradation whereby an acid- and base-stable residue is formed.

12. A process according to any one of the claims 10 to 11, characterized in that the activation via the polyamine units A₁ Aᵢ takes place through a two step process where first non-saturated substituents, preferably alkenyl groups, most preferred allyl groups, are being incorporated at the primary and/or secondary amino groups whereupon the non-saturated substituents are desaturated with halogen water, preferably bromide water, whereupon the coupling with the amines subsequently takes place preferably in an alkaline environment.
